(19) United States
(12) Patent Application Publication
(10) Pub. No.: US 2024/0273972 A1
(43) Pub. Date: Aug. 15, 2024

(54) EFFICIENT GAMING MONITORING USING ARTIFICIAL INTELLIGENCE

(71) Applicant: ANGEL GROUP CO., LTD., Shiga (JP)

(72) Inventors: Subhash CHALLA, Abbotsford, Victoria (AU); Nhat Dinh Minh VO, Abbotsford, Victoria (AU); Duc Dinh Minh VO, Abbotsford, Victoria (AU); Lachlan GRAHAM, Abbotsford, Victoria (AU); Louis QUINN, Abbotsford, Victoria (AU); Mateo DIAZ, Abbotsford, Victoria (AU)

(21) Appl. No.: 18/567,546

(22) PCT Filed: Jun. 10, 2022
(86) PCT No.: PCT/AU2022/050581

§ 371 Date: Dec. 6, 2023

(30) Foreign Application Priority Data
Jun. 10, 2021 (AU) 2021901753
Jun. 28, 2021 (AU) 2021901957
Aug. 24, 2021 (AU) 2021106867

(51) Int. Cl. G07F 17/32; G06V 10/25; G06V 10/44; G06V 10/82; G06V 20/40; G06V 20/52; G06V 20/64; G06V 40/10; G06V 40/20

(52) U.S. Cl. CPC G07F 17/3225; G06V 10/25; G06V 10/44; G06V 10/82; G06V 20/44; G06V 20/52; G06V 20/64; G06V 40/10; G06V 40/20; G07F 17/3206; G07F 17/322

(57) ABSTRACT

Some embodiments relate to methods and systems for gaming monitoring. An example method comprises: receiving by a computing device a series of images and timestamp information of a capture time of each image in the series of images, wherein each image of the series of images is an image of a gaming environment; processing by the computing device a first image in the series of images to determine an event trigger indicator in the first image; identifying a gaming monitoring event based on the determined event trigger indicator; transmitting image data of the first image and images proximate to the first image in the series of images to an upstream computing device; wherein determining the event trigger indicator comprises detection of a first game object in the first image, wherein the first game object was not detected in an image captured prior to the first image in the series of images.

### TECHNICAL FIELD

Described embodiments generally relate to computer implemented methods and computer systems for monitoring gaming activities in gaming premises. Embodiments apply image processing and machine learning processes to monitor gaming activities using distributed computing systems. In particular, some embodiments apply artificial intelligence to image processing for monitoring gaming activities.

### BACKGROUND

Gaming venues such as casinos are busy environments with several individuals engaging in various gaming activities. Gaming venues can be large spaces, which accommodate numerous patrons in different parts of the gaming venue. Several gaming venues comprise tables or gaming tables on which various games are conducted by a dealer or an operator.

Monitoring of gaming environments may be performed by individuals responsible for monitoring. The dynamic nature of gaming, the significant number of individuals who are free to move around the gaming environment and the size of gaming venues often limits the degree of monitoring that could be performed by individuals. Gaming venue operators can benefit from automated monitoring of gaming activity in the gaming venue. Data regarding gaming activities may facilitate data analytics to improve operations and management of the gaming venue or to determine player ratings, for example to award player loyalty bonuses. However, the amount of data generated through such monitoring can be sizeable and can present practical challenges, storage challenges and/or processing challenges.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In this specification, a statement that an element may be “at least one of” a list of options is to be understood that the element may be any one of the listed options, or may be any combination of two or more of the listed options.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a method for gaming monitoring, the method comprising: receiving by a computing device a series of images and timestamp information of a capture time of each image in the series of images, wherein each image of the series of images is an image of a gaming environment; processing by the computing device a first image in the series of images to determine a first event trigger indicator in the first image; identifying a gaming monitoring start event based on the determined first event trigger indicator; responsive to identifying the gaming monitoring start event initiating transmission of image data of the first image and images in the series of images captured subsequent to the first image to an upstream computing device; processing by the computing device a second image in the series of images to determine a second event trigger indicator in the second image, the second image being an image captured subsequent to the first image; identifying a gaming monitoring end event based on the determined second trigger indicator; and terminating transmission of the image data responsive to identifying the gaming monitoring end event.

In some embodiments, determining the first event trigger indicator may comprise detection of a first game object in the first image, wherein the first game object was not detected in an image captured prior to the first image in the series of images.

In some embodiments, determining the first event trigger indicator may comprise detection of a dealer gesture in the first image, the dealer gesture being indicative of a start of a game.

In some embodiments, determining the first event trigger indicator may comprise detection of a person or a part of a person in the first image.

In some embodiments, determining the second event trigger indicator comprises detection of an absence of a game object in the second image.

In some embodiments, determining the second event trigger indicator comprises detection of a dealer gesture in the second image, the dealer gesture being indicative of an end of a game.

The method of some embodiments further comprises capturing the series of images of the gaming environment.

In some embodiments, each image in the series of images may be captured using a camera including one or more of: a visual spectrum camera, or an infrared spectrum camera, or a depth sensing camera, or a neuromorphic camera, or an AI camera, or an event camera, or a pixel processing camera.

In some embodiments, the camera is at a same gaming table location as the computing device.

In some embodiments, the upstream computing device is remote from a location of the computing device.

In some embodiments, the upstream computing device includes a remote server in a cloud computing environment.

The method of some embodiments further comprises determining a region of interest in each of the first image and images in the series of images captured subsequent to the first image; wherein the image data transmitted to the upstream computing device is confined to the image data of the determined regions of interest.

In some embodiments, the region of interest may be a region within the images depicting a game object, or a part of a person. In some embodiments, the game object may comprise one or more of: a game value object, or cash, or a playing card, or one or more dice, or a position marker. In some embodiments, the computing device may be positioned in or proximate to the gaming environment.

In some embodiments, the computing device is a gaming environment computing device is positioned in or proximate to the gaming environment. In some embodiments, the gaming environment includes a gaming table and the captured images include a gaming table surface.

In some embodiments, determining the first event trigger indicator in the first image comprises providing the first image to an artificial intelligence model. In some embodiments, determining the second event trigger indicator in the second image comprises providing the second image to an artificial intelligence model. In some embodiments, the artificial intelligence model is an artificial neural network.

Some embodiments relate to a method for gaming monitoring, the method comprising: receiving at an upstream computing device from a gaming environment computing device in a gaming environment image data of images captured in the a gaming environment and corresponding timestamp information for each of the captured images; processing at the upstream computing device the received image data to detect identify a game object in the image data and an image region of the image data corresponding to the detected identified game object; and processing at the upstream computing device the image region corresponding to the identified game object to determine a game object attribute of the identified game object.

In some embodiments, the game object may comprise a plurality of token objects, and a game object attribute relating to the plurality of token objects may comprise a value estimate of the plurality of token objects and a position indicator of the plurality of token objects. In some embodiments, the position indicator indicates a position of the plurality of token objects on a gaming table in the gaming environment. In some embodiments, the plurality of token objects may be arranged in a stack. In some embodiments, a stack of such token objects may include a single object, but in other embodiments, the stack of token objects has multiple token objects in a contacting and at least partially overlapping arrangement.

In some embodiments, the value estimate of the plurality of token objects is determined by: detecting edge pattern regions in the image region corresponding to the plurality of token objects; processing the edge pattern regions to determine a token value indication encoded in respective edge pattern regions; and estimating the value of the plurality of token objects based on the token value indication.

In some embodiments, detection of the game objects is performed by a first object detection neural network; and the detection of the edge pattern regions and the determination of the token value indication is performed by a second object detection neural network. In some embodiments, the first object detection neural network and the second object detection neural network are implemented using a deep neural network. In some embodiments, the game object comprises a gaming card, and the game object attribute of the gaming card comprises a gaming card identifier.

In some embodiments, the game object comprises a gaming card, and the game object attribute of the gaming card comprises a gaming card identifier.

Some embodiments relate to distributed systems for gaming monitoring. Such distributed systems may comprise: a camera positioned in a gaming environment to capture images of the gaming environment; a gaming environment computing device positioned in or proximate to the gaming environment, the computing device being in communication with the camera; an upstream computing device in communication with the computing device; wherein the gaming environment computing device is configured to perform the method of: receiving by the gaming environment computing device a series of images and timestamp information of a capture time of each image in the series of images, wherein each image of the series of images is an image of a gaming environment; processing by the gaming environment computing device a first image in the series of images to determine a first event trigger indicator in the first image; identifying a gaming monitoring start event based on the determined first event trigger indicator; responsive to identifying the gaming monitoring start event, initiating transmission of image data of the first image and images in the series of images captured subsequent to the first image to an upstream computing device; processing by the gaming environment computing device a second image in the series of images to determine a second event trigger indicator in the second image, the second image being an image captured subsequent to the first image; identifying a gaming monitoring end event based on the determined second trigger indicator; and terminating transmission of the image data responsive to identifying the gaming monitoring end event; and wherein the upstream computing device is configured to perform the method of: receiving at an upstream computing device from a gaming environment computing device in a gaming environment image data of images captured in the gaming environment and timestamp information for each of the captured images; processing at the upstream computing device the received image data to identify a game object in the image data and an image region of the image data corresponding to the identified game object; and processing at the upstream computing device the image region corresponding to the identified game object to determine a game object attribute of the identified game object. Some embodiments relate to a distributed system for gaming monitoring, the distributed system comprising: a camera positioned in a gaming environment to capture images of the gaming environment; a computing device positioned in or proximate to the gaming environment, the computing device being in communication with the camera; an upstream computing device in communication with the computing device; wherein the computing device is configured to perform the method of gaming monitoring according to any one of embodiments, and the upstream computing device is configured to perform the method of gaming monitoring according to any one of the embodiments.

Some embodiments relate to a method for gaming monitoring, the method comprising: receiving by a computing device a series of images and timestamp information of a capture time of each image in the series of images, wherein each image of the series of images is an image of a gaming environment; processing by the computing device a first image in the series of images to determine an event trigger indicator in the first image; identifying a gaming monitoring event based on the determined event trigger indicator; transmitting image data of the first image and images proximate to the first image in the series of images to an upstream computing device; wherein determining the event trigger indicator comprises detection of a first game object in the first image, wherein the first game object was not detected in an image captured prior to the first image in the series of images.

Some embodiments relate to a method for gaming monitoring, the method comprising: receiving by a computing device a series of images and timestamp information of a capture time of each image in the series of images, wherein each image of the series of images is an image of a gaming environment; processing by the computing device a first image in the series of images to determine a first event trigger indicator in the first image; identifying a gaming monitoring start event based on the determined first event trigger indicator; processing by the computing device a second image in the series of images to determine a second event trigger indicator in the second image, the second image being an image captured subsequent to the first image; identifying a gaming monitoring end event based on the determined second trigger indicator; and responsive to identifying the gaming monitoring end event, transmitting image data of a set of images in the series of images from the first image to the second image to an upstream computing device for remote image processing of the set of images using artificial intelligence.

Some embodiments relate to a method for gaming monitoring, the method comprising: receiving by a computing device a series of images and timestamp information of a capture time of each image in the series of images, wherein each image of the series of images is an image of a gaming environment; determining by the computing device a first event trigger indicator in relation to a gaming table in the gaming environment; identifying a gaming monitoring start event based on the determined first event trigger indicator; determining by the computing device a second event trigger indicator in relation to the gaming table at a time after determination of the first trigger event; identifying a gaming monitoring end event based on the determined second event trigger indicator; and one of: subsequent to identifying the gaming monitoring start event, initiating transmission of image data of a first image captured at a time of the first event trigger indicator and images in the series of images captured subsequent to the first image to an upstream computing device for remote image processing of the set of images using artificial intelligence, and subsequent to identifying the gaming monitoring end event, terminating transmission of the image data; or responsive to identifying the gaming monitoring end event, transmitting image data of a set of images in the series of images from the first image captured at a time of the first event trigger indicator to a second image captured at a time of the second event trigger indicator to an upstream computing device for remote image processing of the set of images using artificial intelligence.

In some embodiments, the method further comprises capturing the series of images of the gaming environment. In some embodiments, each image in the series of images is captured using a camera including one or more of: a visual spectrum camera, or an infrared spectrum camera, or a depth sensing camera, or a neuromorphic camera.

In some embodiments, the camera is at a same gaming table location as the computing device. In some embodiments, the upstream computing device is remote from a location of the computing device.

In some embodiments, the upstream computing device includes a remote server in a cloud computing environment.

In some embodiments, the method further comprises determining a region of interest in each of the first image and images in the series of images captured subsequent to the first image; wherein the image data transmitted to the upstream computing device is confined to the image data of the determined regions of interest. In some embodiments, the region of interest is a region within the images depicting a game object, or a part of a person.

In some embodiments, the computing device is a gaming environment computing device positioned in or proximate to the gaming environment. In some embodiments, the gaming environment includes a gaming table and the captured images include a gaming table surface.

Some embodiments relate to a method of gaming monitoring, the method comprising: receiving by an edge computing device a series of images and timestamp information of a capture time of each image in the series of images, wherein each image of the series of images is an image of a gaming environment; processing by the edge computing device a first image in the series of images to determine a first event trigger indicator in the first image; identifying a gaming monitoring start event based on the determined first event trigger indicator; responsive to identifying the gaming monitoring start event, initiating transmission of image data of the first image and images in the series of images captured subsequent to the first image to an upstream computing device; receiving at the upstream computing device from the edge computing device the image data of the first image and each of the images in the series of images captured subsequent to the first image and timestamp information for the first image and images in the series of images; processing at the upstream computing device the received image data to identify a game object in the image data and an image region of the image data corresponding to the identified game object; processing at the upstream computing device the image region corresponding to the identified game object to determine a game object attribute of the identified game object; processing by the edge computing device a second image in the series of images to determine a second event trigger indicator in the second image, the second image being an image captured subsequent to the first image; identifying a gaming monitoring end event based on the determined second trigger indicator; and terminating transmission of the image data responsive to identifying the gaming monitoring end event.

### BRIEF DESCRIPTION OF DRAWINGS

FIG. 1 is a block diagram of a gaming monitoring system 100 according to some embodiments;

FIG. 2 illustrates a block diagram of a part 200 of the gaming monitoring system 100, according to some embodiments;

FIG. 3 illustrates a flowchart of a method of gaming monitoring capable of being performed by an edge computing device, according to some embodiments;

FIG. 4 illustrates a flowchart of a method of gaming monitoring capable of being performed by an upstream computing device, according to some embodiments;

FIG. 5 illustrates a flowchart of a method of gaming monitoring capable of being performed by an edge computing device, according to some embodiments;

FIG. 6 is an image of an example gaming table provided in a gaming environment;

FIG. 7 illustrates an example image region corresponding to a game object obtained from an image of a gaming table in a gaming environment;

FIG. 8 illustrates the image region of FIG. 7 with bounding boxes defined around edge pattern image regions obtained after object detection image processing operations on the image of FIG. 7;

FIG. 9 is a block diagram of an example computer system according to various embodiments;

FIG. 10 is a flowchart of a method of gaming monitoring capable of being performed by an edge computing device, according to some embodiments; and

FIG. 11 is a flowchart of a method of gaming monitoring capable of being performed by an edge computing device, according to some embodiments.

### DESCRIPTION OF EMBODIMENTS

Various table-based games are played in gaming venues. Games may include: baccarat, blackjack, roulette, and craps, for example. Such games may involve a random event or a series of random events with a random or unpredictable outcome over which players may make wagers. The random events may include drawing or allocation of a card or throwing of dice or a roll of a roulette wheel. Players participate in a game by placing game objects, at certain locations on a gaming table. Game objects may include chips or tokens issued by the gaming venue, or coins or notes, for example. In several games, the tables have defined zones or areas that are associated with specific outcomes in the game. For example, in the game of baccarat, the gaming table comprises zones or regions on the table surface corresponding to a player and a banker. Bets on specific outcomes or a random event in a game may be placed by patrons by placing game objects in the respective zones or regions associated with specific outcomes. With several players participating in games, some seated and others not seated, and each player placing wagers on different zones or regions in a fast-paced gaming environment, it may be challenging to monitor the activity of each player. In addition, players may move through various gaming tables in a venue over the course of a visit, making monitoring each player over the course of their visit more challenging.

Due to the dynamic and fast paced nature of gaming environments, monitoring and surveillance of gaming events using image data can be highly computationally intensive. In order to identify objects or identify events in a gaming environment with a reasonable degree of confidence, often a high resolution of image data is required. For example, image data with a resolution of 720p (1280×720), 1080p (1920×1080), 4 MP (2560×1920) or greater may be captured at a frame rate of 25 frames per second or greater. Gaming premises may comprise a very large number of gaming environments. For example, gaming premises may comprise a thousand or more gaming environments. Each gaming environment may include a gaming table or a gaming area where gaming may occur. Each gaming environment may be monitored using one or sensor such as a camera. A camera capturing image data at a resolution of 1080p at 30 frames per second may generate image data at a rate of 2.5 mbps (megabytes per second). In a gaming premises with 1000s of gaming environments, with each gaming environment fitted with two cameras, the total image data may be generated at a rate of 5 gbps, for example. In some embodiments, the image data may also comprise data from a camera capturing images in an image spectrum not visible to the naked eye (infrared spectrum for example). In some embodiments, the image data may also comprise data from a depth sensor or a depth camera or a 3D camera capturing depth or 3D scene information of a gaming environment. The additional sources of image data may further increase the volume and velocity of image data generated from surveillance of gaming environments.

The significant frequency and volume of data generated by sensors monitoring gaming environment requires a specific distributed computing architecture to efficiently process the image data and derive insights from the captured data. Gaming activity monitoring applications may operate under constraints associated with response time or latency of the monitoring of gaming activity. For example, a gaming monitoring operation of estimating a value of a bet placed in a gaming environment may be required to be performed at a response time of around 2 seconds, for example. Response times may be measured with the starting point as a point of time a first image depicting a monitored gaming activity is captured by a camera in the gaming environment. Images captured by a camera in the gaming environment may be processed by the various computing devices implementing a distributed computing system to detect events based on the captured images and identify or estimate parameters or attributes associated with the detected events. Various computing devices part of the distributed computing system of the embodiments may have limited processing power and limited memory to enable computations. Each computing device in the distributed computing systems of the embodiments may be configured to perform a part of the image processing or computation operations and may be subjected to a specific response time or latency constraint by virtue of its hardware configuration and dependencies on other computing devices performing computations in coordination. The embodiments advantageously provide a distributed computing system that optimises the execution of computations using distinct computing devices part of a distributed computing system for monitoring gaming activity in a gaming environment to meet desired latency and/or scalability needs.

Gaming environments also impose additional constraints on deployment of distributed computing systems. For example, placement of a computing device in a gaming environment (for example near or underneath a gaming table) for execution of processing power intensive operations may generate an undesirable amount of heat creating a safety risk, such as a fire risk. Within the tight constraints of a gaming environment including physical space, power and security constraints, it may not be possible to provide suitable cooling capabilities in the gaming environment.

The embodiments provide an improved distribution of computing operations within distributed computing environments deployed in gaming premises to meet the constraints imposed by the gaming environment while providing the computing capability to effectively monitor large gaming environments. The embodiments also provide distributed computing systems that scale to cover larger premises or that could be dynamically scaled depending on variations in occupancy within the premises. The embodiments also allow for dynamic variations in the degree of monitoring or monitoring capabilities implemented by the distributed monitoring systems. For example, additional monitoring capabilities may be efficiently deployed by the distributed monitoring system across some or all gaming environments within gaming premises using the distributed computing system. The embodiments also enable scaling of the distributed computing systems to monitor more than one gaming premises (for example to monitor more than one casinos).

The embodiments relate to computer implemented methods and computer systems to monitor gaming activity in gaming premises using distributed computing systems. Some embodiments incorporate one or more edge sensors or cameras positioned to capture images of a gaming environment including a gaming table. The one or more cameras are positioned to capture images of the gaming table and also images of players in the vicinity of the gaming table participating in a game. The embodiments incorporate image processing techniques including object detection, object tracking, pose estimation, image segmentation, and face recognition, to monitor gaming activity. Embodiments rely on machine learning techniques, including deep learning techniques, to perform the various image processing tasks. Some embodiments perform the gaming monitoring tasks in real-time or near real-time use the machine learning techniques to assist the gaming venue operators in responding to gaming anomalies or irregularities expediently.

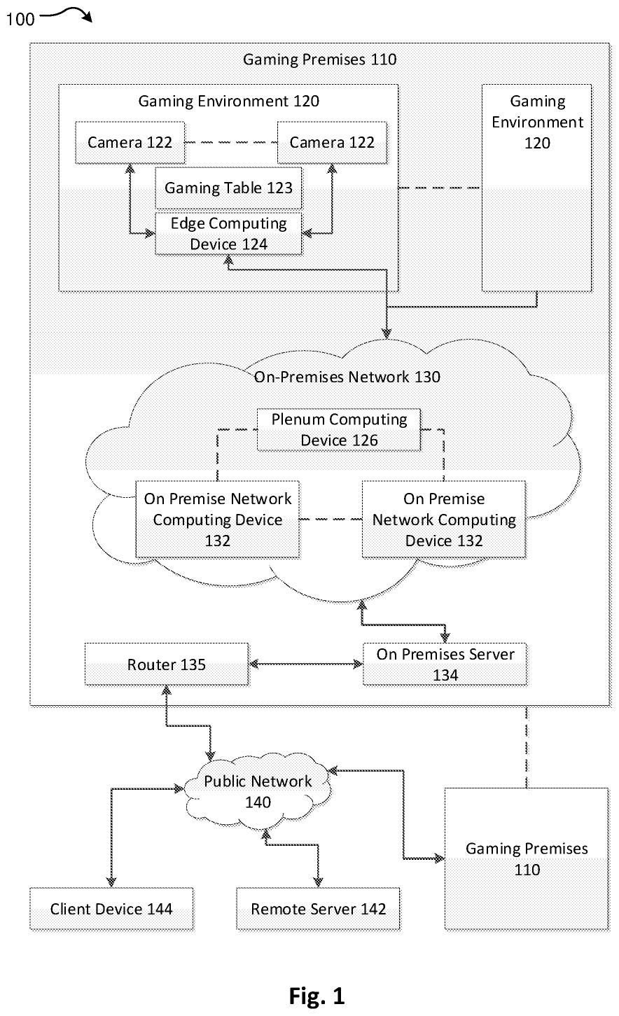

FIG. 1 is a block diagram of a gaming monitoring system 100 according to some embodiments. The gaming monitoring system 100 may be configured to monitor gaming activity in multiple gaming environments 120 within a gaming premises or venue 110. Some embodiments may also be scalable to monitor gaming activity in more than one gaming premises 110.

The gaming environment 120 may include a gaming table 123, typically within an area of a building, and an area adjacent to the gaming table 123 including a seating area or a standing area for patrons. The gaming environment 120 may also include a gaming room or a gaming area designated for conducting a game.

The gaming monitoring system 100 may comprise at least one camera or edge sensor 122 deployed in each gaming environment 120. The camera 122 may include a camera capturing images in a spectrum visible to the human eye, or a camera capturing images in a spectrum not visible to the human eye, or a depth sensing camera or a neuromorphic camera, for example. In some embodiments, more than one camera 122 may be deployed in a gaming environment. Including more than one camera 122 (for example, more than one camera) may allow the capture of additional image data relating to the gaming environment to allow a more comprehensive monitoring of the gaming environment 120. Each camera 122 may capture images of a surface of a gaming table 123 in the gaming environment 120 from a different perspective.

In some embodiments, the camera 122 may be or comprise one or more of: a visual spectrum camera, or an infrared spectrum camera, or a depth sensing camera, or a neuromorphic camera, or an AI camera, or an event camera, or a pixel processing camera.

The camera 122 may capture images at a resolution of 1280×720 pixels or higher, for example. The camera may capture images at a rate of 20 frames per second or higher, for example. In some embodiments, the may include a See3CAM 130, a UVC-compliant AR1335 sensor based 13 MP autofocus USB camera. In some embodiments, the camera may include an AXIS P3719-PLE Network Camera.

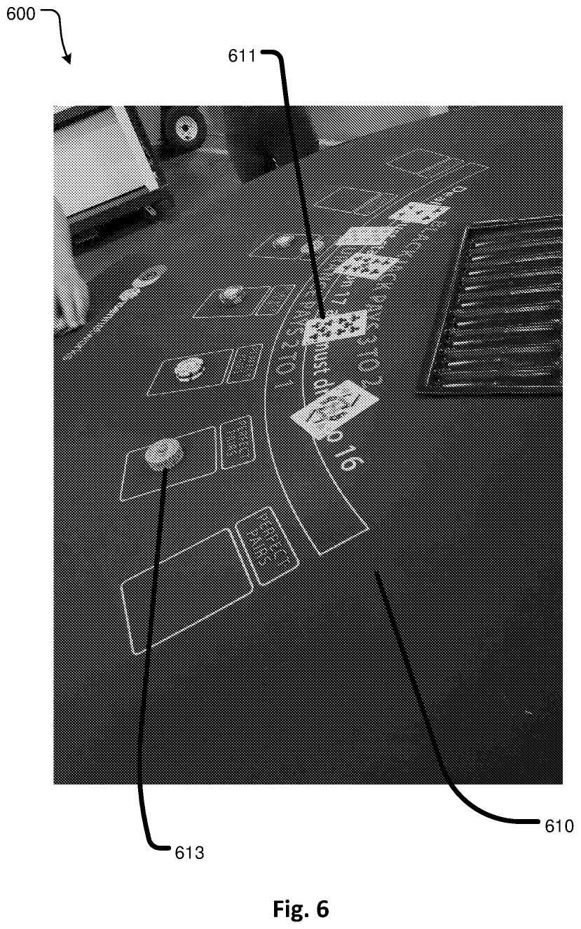

The camera 122 may be positioned or mounted on a wall or pedestal or pole with a substantially uninterrupted view of the gaming environment 120 and oriented to capture images in a direction looking from a dealer side 123a (FIG. 6) of a gaming table 123 toward a player side 123b (FIG. 6), for example.

The gaming monitoring system 100 also comprises a computing device or an edge computing device 124 provided in or proximate to the gaming environment 120 in communication with the camera 122. The computing device 124 is configured to communicate with camera 122 and any additional cameras in the gaming environment 120. Communication between the computing device 124 and the cameras 122 may be provided through a wired medium such as a Universal Serial Bus cable, for example. In some embodiments, communication between the computing device 124 and the cameras 122 may be provided through a wireless medium such as a Wi-Fi network or other short-range, low power wireless network connection.

The computing device 124 may be positioned in a vicinity of the gaming environment 120 being monitored. For example, the computing device 124 may be positioned in a closed chamber or cavity underneath a gaming table 123 within the gaming environment 120. In some embodiments, the computing device 124 may be positioned away from the gaming environment 120 but configured to communicate with the camera 122 over a wired or wireless communication link.

In some embodiments, the edge computing device 124 may be tightly integrated or coupled with the edge sensor or camera 122. For example, the edge computing device 124 and the edge sensor 122 may be provided in a single physical unit. In some embodiments, the computing device 124 may comprise an image processing engine, image processing unit (IPU), or image signal processor (ISP) tightly integrated into the camera 122.

In some embodiments, the gaming monitoring system 100 may also comprise one or more plenum computing devices 126 in communication with the edge computing device 124. A plenum computing device 126 may include a computing device provided in a space in a ceiling or under the floor in the gaming premises 110 where various cables connecting the various components of the gaming monitoring system 100 may be positioned. In some embodiments, the gaming monitoring system 100 may not necessarily comprise the edge computing device 124, and one or various functions and operations of the edge computing device 124 may be performed by a plenum computing device 126. In some embodiments, the gaming monitoring system 100 need not necessarily comprise the plenum computing device 126, and one or various functions and operations of the plenum computing device 126 may be performed by the edge computing device 124.

The gaming monitoring system 100 comprises an on-premises or local network 130. The local network 130 enables communication between the various components of the gaming monitoring system 100 deployed in the gaming premises 110. In some embodiments, the local network 130 may comprise one or more on-premises network computing device or a mid-span computing device 132. In some embodiments, the on-premises network computing device 132 may be configured to perform some of the computational operations, including image processing operations before transmitting image data capture by the camera 122 to the on premise server 134. The gaming monitoring system 100 of some embodiments need not necessarily comprise the on-premises network computing device 132.

The gaming monitoring system 100 comprises at least one on premise server 134 configured to receive image data from the camera 122 or image data processed by one or more of the edge computing device 124, the plenum computing device 126, and the on premise network computing device 132. In some embodiments, the on premise network computing device 132 may be physically located in a designated network device location within the gaming premises 110. The designated location may include a network closet or a network room with access to electrical and network wiring. The on premise server 134 may perform image processing operations and transmit an output of the image processing operations to a remote server 142 or a client device 144 over a public network 140. In some embodiments, the on premise server 134 may be located in an on premise data centre provided in a secure part of the gaming premises 110.

In some embodiments, parts on the image processing operations or computations for gaming monitoring may be performed by the remote server 142. The remote server 142 may be located in an enterprise data centre located away from the gaming premises 110. In some embodiments, the remote server 142 may be located in a cloud computing environment located away from the gaming premises 110.

The plenum computing device 126, the on premise network computing device 132, the on premise server 134 and the remote server 142 may be collectively referred to as upstream computing device or upstream computing components given they are located away from the gaming environment and away from cameras 122 capturing the image data of the gaming environment. The plenum computing device 126 and the on premise network computing device 132 may be implemented using network devices such as routers and/or switches or a combination of routers and switches. In some embodiments, the plenum computing device 126 and the on premise network computing device 132 may be implemented using a common computing device or as part of the same server system.

Some embodiments may not include the plenum computing device 126 and the various processing operations of the plenum computing device 126 may be performed by the on premise network computing device 132. Some embodiments may not include the on premise server 134. The various processing operations of the on premise server 134 is such embodiments may be performed by the on premise network computing device 132 and/or the plenum computing device 126. In embodiments not comprising the on premise server 134, communication between the on premises network 130 and the public network 140 may be facilitated using a router 135.

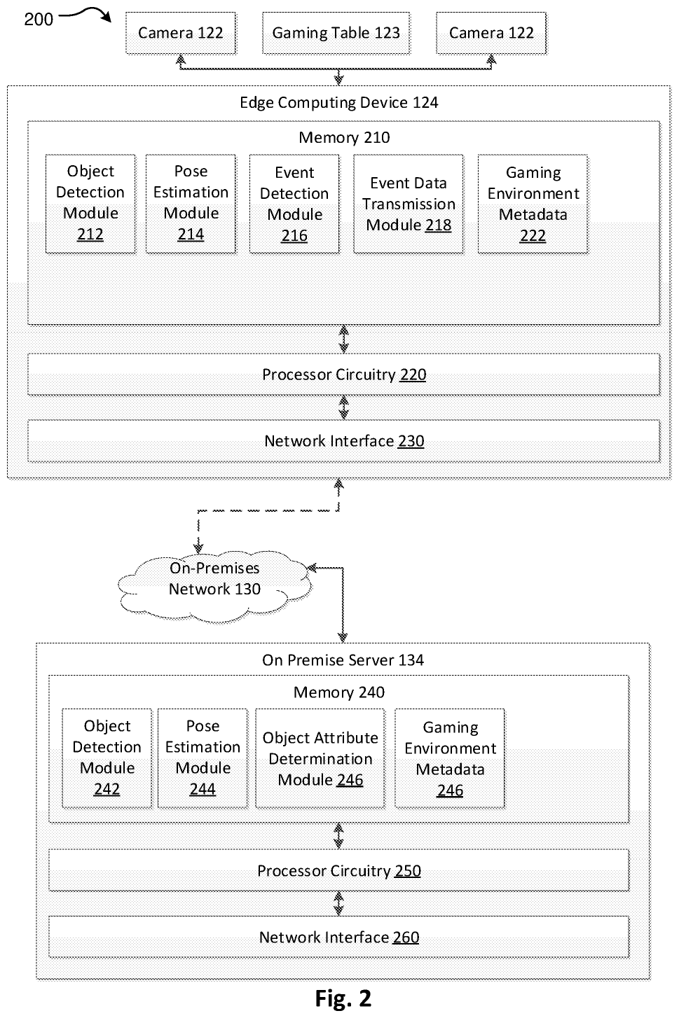

FIG. 2 illustrates a block diagram of a part 200 of the gaming monitoring system 100, according to some embodiments. The edge computing device 124 comprises processor circuitry 220 including at least one processor (referred to herein for convenience as processor 220) in communication with a memory 210 and a network interface 230. Memory 210 may comprise both volatile and non-volatile memory. The network interface 230 may enable communication with other devices such as camera 122 and communication over the on premise network 130, for example.

Memory 210 stores executable program code to provide the various computing capabilities of the gaming monitoring system 100 described herein. Memory 210 comprises at least: an object detection module 212, a pose estimation module 214, an event detection module 216, an event data transmission module 218, and gaming environment metadata 222.

The on premise server 134 comprises processor circuitry 250 including at least one processor (referred to herein for convenience as processor 250) in communication with a memory 240 and a network interface 260. Memory 240 may comprise both volatile and non-volatile memory. The network interface 260 may enable communication with other devices within the gaming monitoring system 100.

Memory 240 stores executable program code to provide the various computing capabilities of the gaming monitoring system 100 described herein. Memory 210 comprises at least: an object detection module 242, a pose estimation module 244, an object attribute determination module 246, and gaming environment metadata 246.

The various modules stored in the memory 210 and 240 for execution by the processor 220 or processor 250 may incorporate or have functional access to machine learning based data processing models or computation structures to perform the various tasks associated with monitoring of gaming activities. In particular, software code modules of various embodiments may have access to Artificial Intelligence models that incorporate deep learning based computation structures, including artificial neural networks (ANNs). ANNs are computation structures inspired by biological neural networks and comprise one or more layers of artificial neurons configured or trained to process information. Each artificial neuron comprises one or more inputs, and an activation function for processing the received inputs to generate one or more outputs. The outputs of each layer of neurons are connected to a subsequent layer of neurons using links. Each link may have a defined numeric weight which determines the strength of a link as information progresses through several layers of an ANN. In a training phase, the various weights and other parameters defining an ANN are optimised to obtain a trained ANN using inputs and known outputs for the inputs. The optimisation may occur through various optimisation processes, including back propagation. ANNs incorporating deep learning techniques comprise several hidden layers of neurons between a first input layer and a final output layer. The several hidden layers of neurons allow the ANN to model complex information processing tasks, including the tasks of object detection and pose estimation performed by the gaming monitoring system 100.

In some embodiments, various modules implemented in the memory 210 and 240 may incorporate one or more variants of convolutional neural networks (CNNs) in performing image processing, a class of deep neural networks to perform the various image processing operations for gaming monitoring. CNNs comprise various hidden layers of neurons between an input layer and an output layer that convolve an input to produce the output through the various hidden layers of neurons.

The object detection modules 212 and 242 comprises program code to detect particular objects in images or image data of images captured by camera 122. Objects detected by the object detection modules 212 and 242 may comprise game objects such as chips, cash, coins or notes placed on a surface 610 (FIG. 6) of gaming table 123 in the gaming environment 120. The object detection modules 212 and 242 may also be trained to determine a region or zone of the gaming table 123 where the game object is or can be detected. An outcome of the object detection process performed by the object detection modules 212 and 242 may be or include information regarding a class to which each identified object belongs and information regarding the location or region of the gaming table 123 where an identified object is detected. The location of identified objects may be indicated by image coordinates of a bounding box surrounding a detected object or an identifier of the region of the gaming table 123 in one or more images where the object was detected, for example. The outcome of object detection may also comprise a probability number associated with a confidence level of the accuracy of the class of the identified object, for example. The object detection module 212 and 242 may also comprise program code to identify a person, a face or a specific body part of a person in an image. The object detection module 212 and 242 may comprise a game object detection neural network trained to process images of the gaming table 123 and detect game objects in images captured by camera 122. The object detection module 212 and 242 may also comprise a person detection neural network trained to process an image and detect one or more persons in the image or parts of one or more persons, for example faces. The object detection modules 212 and 242 may results in the form of coordinates in a processed image defining a rectangular bounding box around each detected object. The bounding boxes may overlap for objects that are placed next to each other or are partially overlapping in an image.

The object detection modules 212 and 242 may incorporate a region based convolutional neural network (R-CNN) or one of its variants including Fast R-CNN or Faster-R-CNN or Mask R-CNN, for example, to perform object detection. The R-CNN may comprise three modules: a region proposal module, feature extractor module and a classifier module. The region proposal module is trained to determine one or more candidate bounding boxes around potentially detected objects in an input image. The feature extractor module processes parts of the input image corresponding to each candidate bounding box to obtain a vector representation of the features in each candidate bounding box. In some embodiments, the vector representation generated by the feature extractor module may comprise 4096 elements. The classifier module processes the vector representations to identify a class of the object present in each candidate bounding box. The classifier module generates a probability score representing the likelihood of presence of each class or objects in each candidate bounding box. For example, for each candidate bounding box, the classifier module may generate a probability of whether the bounding box corresponds to a person or a game object. Based on the probability scores generated by the classifier module and a predetermined threshold value, an assessment may be made regarding the class of object present in the bounding box. In some embodiments, the classifier may be implemented support vector machine. In some embodiments, the object detection module 123 may incorporate a pre-trained ResNet based convolutional neural network (for example ResNet-50) for feature extraction from images to enable the object detection operations.

In some embodiments, the object detection modules 212 and 242 may incorporate a You Only Look Once (YOLO) model for object detection. The YOLO model comprises a single neural network trained to process an input image and predict bounding boxes and class labels for each bounding box directly. The YOLO model splits an input image into a grid of cells. Each cell within the grid is processed by the YOLO model to determine one or more bounding boxes that comprise at least a part of the cell. The YOLO model is also trained to determine a confidence level associated with each bounding box, and object class probability scores for each bounding box. Subsequently the YOLO model considerers each bounding box determined from each cell and the respective confidence and object class probability scores to determine a final set of reduced bounding boxes around objects with an object class probability score higher than a predetermined threshold object class probability score.

In some embodiments, the object detection module 212 and 242 implements one or more image processing techniques described in the published PCT specifications ‘System and method for machine learning driven object detection’ (publication number: WO/2019/068141) or ‘System and method for automated table game activity recognition’ (publication number: WO/2017/197452), the contents of which are hereby incorporated by reference.

The pose estimation modules 214 and 244 comprise executable program code to process one or more images of players in a gaming environment to identify postures of the one or more players. Each identified posture may comprise a location of a region in an image corresponding to a specific body part of a player. For example, the identified body parts may comprise left or right hands, left or right wrists, a left or right distal-hand periphery in an image, or a face.

The pose estimation modules 214 and 244 may be configured to identify postures of multiple persons in a single image without any advance knowledge of the number of persons in an image. Since gaming venues are dynamic and fast paced environments with several patrons moving through different parts of the venue, the capability to identify multiple persons helps to improve the monitoring capability of the gaming monitoring system 100. The pose estimation modules 214 and 244 may comprise a key point estimation neural network trained to estimate key points corresponding to specific parts of one or more persons in an input image. The pose estimation modules 214 and 244 may comprise a 3D mapping neural network trained to map pixels associated with one or more persons in an image to a 3D surface model of a person.

In some embodiments, pose estimation may involve a top down approach, wherein a person in an image is identified first, followed by the posture or the various parts of the person. The object detection modules 212 and 242 may be configured to identify portions or regions of an image corresponding to a single person. The pose estimation modules 214 and 244 may rely on the identified portions or regions of the image corresponding to a single person and process each identified portion or region of the image to identify the posture of the person.

In some embodiments, pose estimation may involve a bottom up approach, wherein various body parts of all persons in an image are identified first, followed by a process of establishing relationships between the various parts to identify the postures of each person in the image. The object detection modules 212 and 242 may be configured to identify portions or regions of an image corresponding to specific body parts of persons, such as a face, hands, shoulders, or legs, for example. Each specific portion or region in an image corresponding to a specific body part may be referred to as a key point. The pose estimation modules 214 and 244 may receive from the object detection modules 212 and 242 information regarding the identified key points, for example coordinates of each key point and the body part associated with each key point. Based on this received information, the pose estimation modules 214 and 244 may relate the identified key points with each other to identify a posture of one or more persons in the image.

In some embodiments, the pose estimation modules 214 and 244 may incorporate the OpenPose framework for pose estimation. The OpenPose framework comprises a first feedforward ANN trained to identify body part locations in an image in the form of a confidence map. The confidence maps comprise an identifier for a part identified in a region of an image, and a confidence level in the form of a probability of confidence associated with the detection. The first feedforward ANN is also trained to determine part affinity field vectors for the identified parts. The part affinity field vectors represent associations or affinity between the parts identified in the confidence map. The determined part affinity field vectors and the confidence maps are iteratively pruned by a Convolutional Neural Network (CNN) to remove weaker part affinities and ultimately predict a posture of one or more persons in an image. Output of the pose estimation modules 214 and 244 may comprise co-ordinates or each part (key point) identified for each person identified in an image and an indicator of the class that each part belongs to, for example whether the identified part is a wrist, or hand or knee.

The event detection module 216 of the edge computing device comprises program code to identify gaming events based on the image data received by the edge computing device 124. In some embodiments, the event detection module 216 may identify gaming events based on the output of the object detection module 212 and/or output of the pose estimation module 214. The gaming events may be relate to the start of a game, or an end of a game, or a specific stage in the conduct of a game, for example and end of the opportunity to place game objects on a gaming table surface 610 in the game of roulette. In some embodiments, the gaming event may relate to the placement of a bet on a gaming table surface 610 in the gaming environment 120.

The gaming event may be identified based on one or more trigger conditions. For example, to identify the start of a game, a trigger condition be the detection of a first game object (playing card or token game object) placed on a gaming table surface 610 in the gaming environment 120. Similarly, an end of a game may be identified based on the trigger condition of removal or disappearance of a last game object or all game objects from a gaming table surface 610 in the gaming environment 120. Object detection information determined by the object detection module 212 may allow the event detection module 216 to apply predefined event triggers to object detection information to identify an event.

Responsive to the event detection performed by the event detection module 216, the event data transmission module 218 may transmit image data relating to the detected event to an upstream computing device for further processing. In embodiments, where the detected events include the start and end of games, the transmitted image data may relate to images captured between the detection of the start of a game and end of a game. In some embodiments, the transmitted image data may include only a subset of the capture image data or image data of one or more regions of interest identified by the object detection module 212 or the pose estimation module 214.

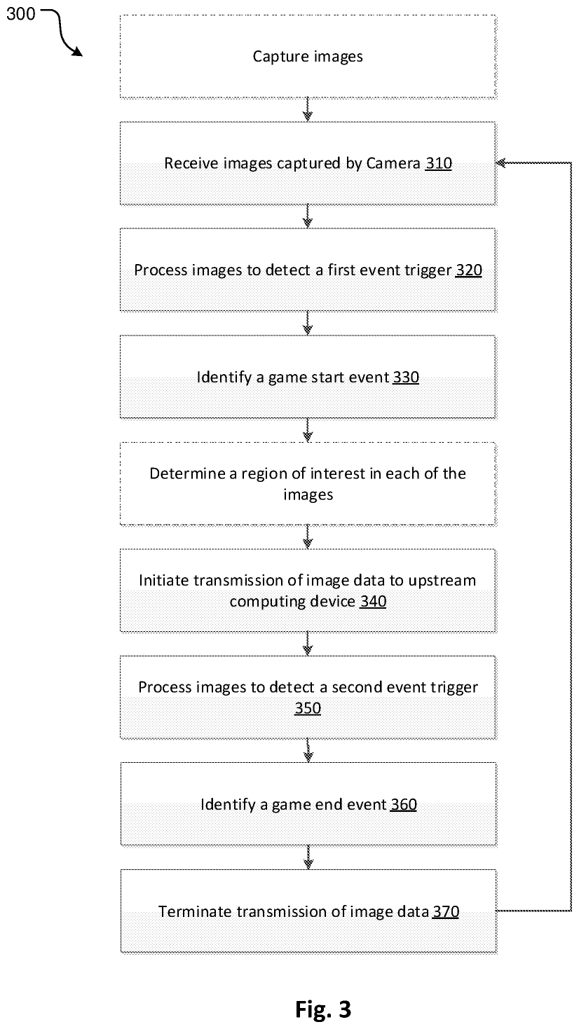

FIG. 3 illustrates a flowchart of a method 300 of gaming monitoring capable of being performed by an edge computing device, according to some embodiments. The method 300 performs image processing operations to identify images or image regions that are of interest for gaming monitoring. In some embodiments, cameras 122 may continuously capture images of the gaming environment 120. However, for various periods, no gaming activity of interest may occur in the gaming environment. Storing and transmission of images that do not include a gaming activity of interest may result in a wastage of computational, network and memory resources in the gaming monitoring system. In some embodiments, the edge computing device 124 serves as a gatekeeper of image data generated by the cameras 122 and performs the image processing operations necessary to identify image data relating to gaming events of interest that could be processed by the upstream computing devices to identify further insights.

At 310, the edge computing device 124 receives a series of images of the gaming environment and timestamp information of a capture time of each image in the series of images. The series of images may be captured by one or more cameras 122. The timestamp information is used to determine temporal image order of an image from among multiple images. The timestamp information may include a numerical time value and/or a value indicative of a relative time value or temporal order. At 320, the edge computing device 124 processes a first image in the series of images to determine a first event trigger indicator in the first image. The first event trigger indicator may include a detection of one or more game objects or one or more persons by the object detection module 212 in the first image. The edge computing device 124 may determine the first event trigger using one or more artificial intelligence models. In some embodiments, the one or more artificial intelligence models may be or include an artificial neural network, a convolutional neural network, a fully convolutional neural network or any other suitable type of artificial intelligence or deep learning model.

At 330, the edge computing device 124 identifies a gaming monitoring start event based on the determined first event trigger indicator. The gaming monitoring start event may relate to the start of a game on a gaming table 123 in the gaming environment 120. Responsive to identifying the start of a game event, at 340 the edge computing device 124 initiates transmission of image data of the first image and images in the series of images captured subsequent to the first image to an upstream computing device. The initiated transmission may be effectively continued transmission or such repeated frequent transmission (until the second event trigger is determined) that the transmission appears to be effectively continuous.

At 350, the edge computing device 124 processes a second image in the series of images to determine a second event trigger indicator in the second image. The second image being an image captured subsequent to the first image in the series of images capture by the camera 122. The edge computing device 124 may determine the second event trigger using one or more artificial intelligence models. In some embodiments, the one or more artificial intelligence models may be or include an artificial neural network, a convolutional neural network, a fully convolutional neural network or any other suitable type of artificial intelligence or deep learning model.

At 360, the edge computing device 124 identifies a gaming monitoring end event based on the determined second trigger indicator. Responsive to the determination of the gaming monitoring end event, the edge computing device 124 terminates the transmission of the image data initiated at 340.

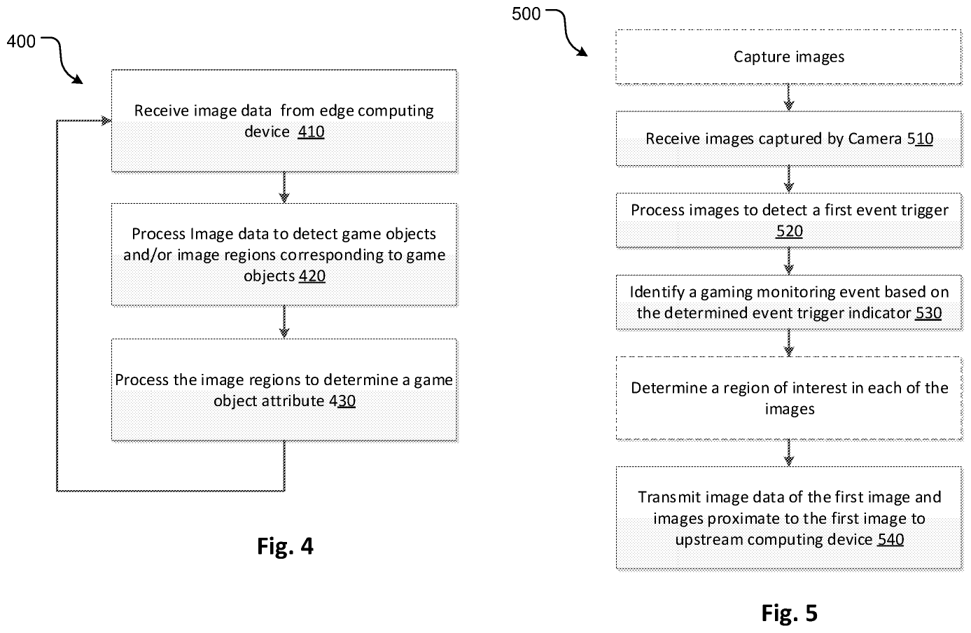

FIG. 4 illustrates a flowchart of a method 400 of gaming monitoring capable of being performed by one or a combination of more than one upstream computing device, according to some embodiments. Each step of the method 400 may be partially performed by one computing device among the upstream computing devices, with the rest of the step being completed by the rest of the upstream computing devices. In this description, the term upstream computing device is intended to include a system of multiple upstream computing devices in combination. In some embodiments, the various upstream computing devices may be configured to cooperate with each other to perform the various steps of method 400.

At 410, the upstream computing device receives the image data transmitted by the edge computing device 124. At 420, the received image data is processed by the upstream computing device to perform object detection, and/or pose estimation to identify objects or persons associated with objects in the received image data. At 420, the upstream computing device may also identify image regions in the received data corresponding to game objects. At 430, the upstream computing device processes the image regions identified at 420, or the images received at 410, to identify game object attributes. The game objects may comprises a plurality of game tokens or game token objects, each of which has an associated numerical value relevant to the game being played. The associated numerical value may be an integer value, such as a value of 10, 50 or 100, for example. The game object attribute relating to the plurality of token objects may comprise a value estimate of each and/or all of the plurality of token objects and a position indicator of the plurality of token objects. In some embodiments, the value estimation of the plurality of token object may be performed according to one or more image processing techniques described in the published PCT specifications ‘System and method for machine learning driven object detection’ (publication number: WO/2019/068141) or ‘System and method for automated table game activity recognition’ (publication number: WO/2017/197452), the contents of which are hereby incorporated by reference.

FIG. 5 illustrates a flowchart of a method 500 of gaming monitoring capable of being performed by an edge computing device, according to some embodiments. At 510, the edge computing device 124 receives a series of images of the gaming environment and timestamp information of a capture time of each image in the series of images. The timestamp information is used to determine temporal image order of an image from among multiple images. The timestamp information may include a numerical time value and/or a value indicative of a relative time value or temporal order. The series of images may be images captured by one or more of cameras 122. At 520, the edge computing device 124 processes a first image in the series of images to determine an event trigger indicator in the first image. The first event trigger indicator may include a detection of one or more game objects or one or more persons by the object detection module 212 in the first image, for example. Other selected image content in the captured images may result in determination of the event image trigger indicator.

In some embodiments, the edge computing device may determine the first event trigger by digital image processing using one or more artificial intelligence models. In some embodiments, the one or more artificial intelligence models may be or include an artificial neural network, a convolutional neural network, a fully convolutional neural network or any other suitable type of artificial intelligence or deep learning model.

At 530, the edge computing device 124 identifies a gaming monitoring event based on the determined event trigger indicator. The identification of a gaming monitoring event based on the determined event trigger indicator may be based on matching at least one trigger rule from among a set of trigger rules stored in memory 210. The gaming monitoring event may relate to an event of interest for monitoring, including the placement of a bet, an outcome of a game, a placement of a game object or a playing card. Responsive to identifying the game event, at 540 the edge computing device 124 initiates transmission of image data of the first image and images in the series of images that are proximate to the first image to an upstream computing device. The proximate images may include images captured within 1 second or 0.5 second or 0.25 second or 0.1 second before and after the first image was captured. In some embodiments, the proximate images may include 1 to 10 images captured immediately before and after the first image. The transmission of additional images with reference to the first image allows the execution of redundant image processing operations and data fusion based on the series of images to determine more accurate game object attributed by an upstream computing device.

FIG. 6 is an image 600 of an example gaming table 123 provided in a gaming environment 120 captured by camera 122. Illustrated in image 600 is a gaming table surface 610 of the gaming table 123. Resting on the gaming table surface 610 is a stack of first game objects, shown in the example form of game token objects 613, and second game objects, shown in the example form of cards 611. The object detection module 212 or 242 may be configured to process images such as image 600 to determine image regions corresponding to game objects 613 and/or cards 611. Determination of image regions corresponding to game objects 613 and/or cards 611 may serve as a first event trigger as described by reference to step 320 of FIG. 3.

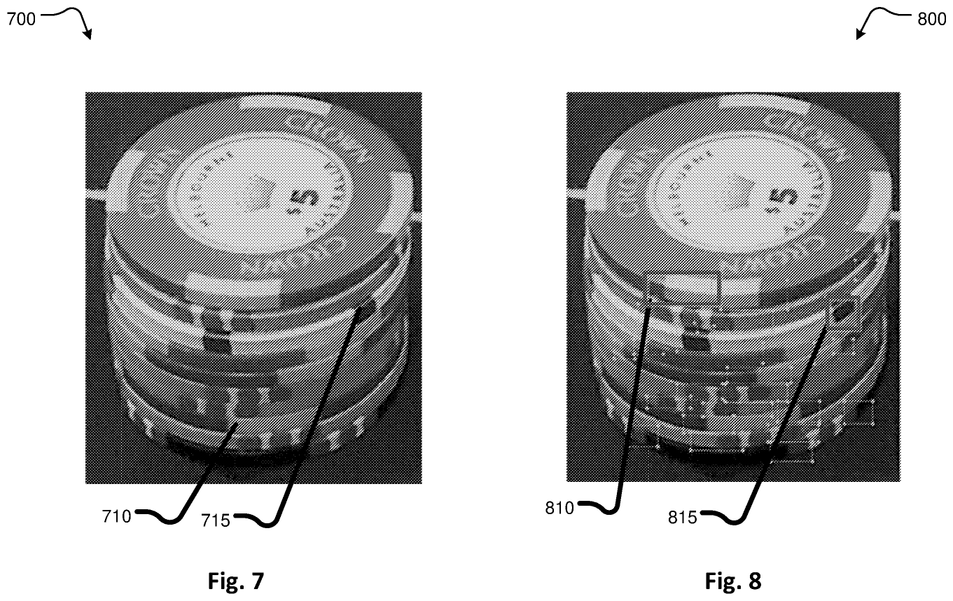

FIG. 7 illustrates an image region 700 from an image captured by camera 122 in a gaming environment 120. The image region 700 may have been identified by the object detection module 212 or 242 as an image region corresponding to a stack of game objects. Illustrated in image region 700 are game object edge patterns 710 and 715 associated with edge regions of individual game objects within the stack of game objects 613, such as is shown in FIG. 6. The object detection module 212 or 242 may be configured to process image region 700 to determine or identify all identifiable edge patterns in image region 700. The edge patterns 710, 715 may be distinctive for each of multiple categories of the same kinds of game objects. The edge patterns 710, 715 may be indicative of a value associated with each game object. The gaming monitoring system 100 may be configured to perform the image processing operations to detect image regions corresponding to each edge pattern based on the techniques described in the PCT specification ‘System and method for machine learning driven object detection’ (publication number: WO/2019/068141), for example.

FIG. 8 illustrates the image region 700 with two exemplary bounding boxes 810 and 815 defined around respective edge patterns on edge regions of different game objects in a same game object stack. The bounding boxes 810 and 815 may be determined for identified edge patterns based on the image processing operations performed by the object detection module 212 or 242, for example.

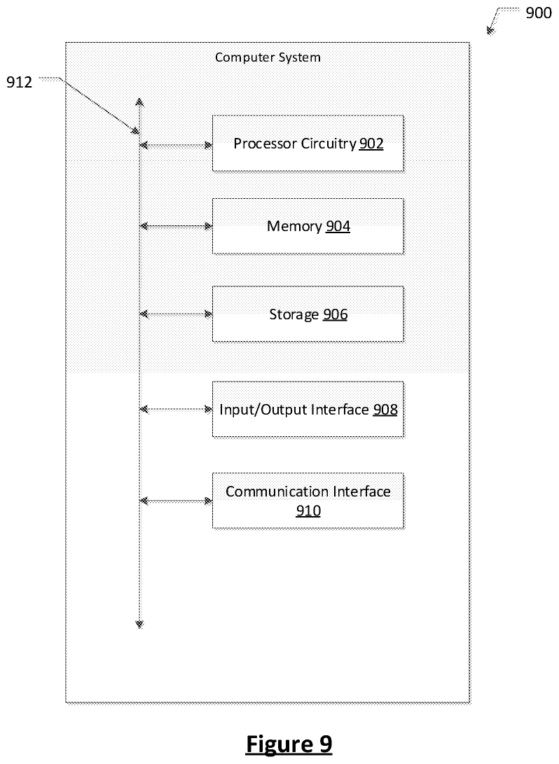

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Reference to a computer system or computing may encompass one or more computer systems or devices, where appropriate. The edge computing device 124, plenum computing device 126, on-premise network computing device 132, on-premises network 130, on-premises server 134, public network 140, client device 144 and remote server 142 may incorporate a subset or all of the computing components described with reference to the computer system 900 to provide the functionality described in this specification.

This disclosure contemplates any suitable number of computer systems 900 to implement each of the edge computing device 124, plenum computing device 126, on-premise network computing device 132, on-premises network 130, on-premises server 134, public network 140, client device 144 and remote server 142. Computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real-time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes processor circuitry 902 (referred to herein for convenience as processor 902), memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor (including highly parallel multi-core processors such as GPUs, TPUS, VPUs, in-memory processors and the like); be an FPGA; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

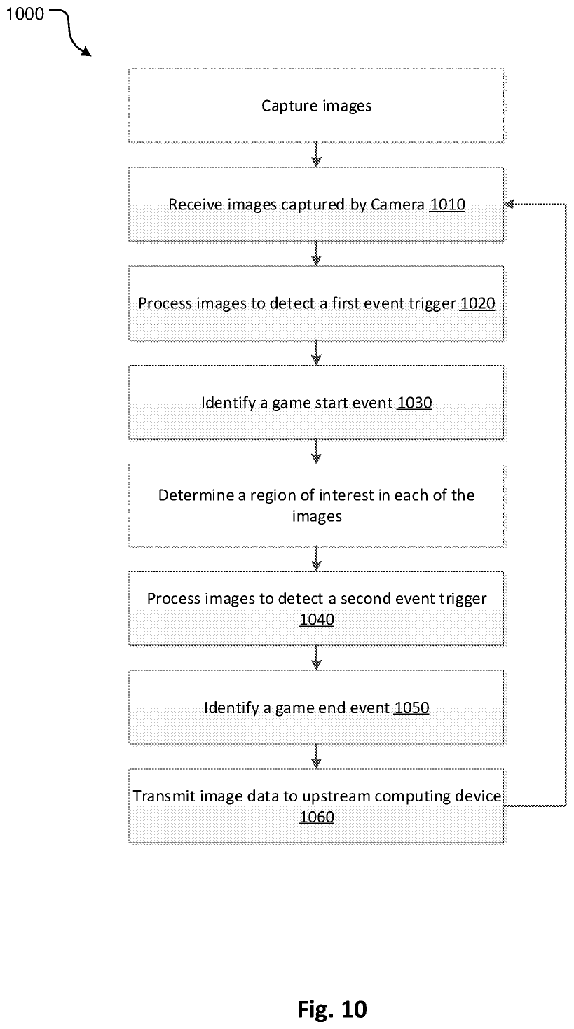

FIG. 10 illustrates a flowchart of a method 1000 of gaming monitoring capable of being performed by an edge computing device, according to some embodiments. The method 1000 performs image processing operations to identify images or image regions that are of interest for gaming monitoring. In some embodiments, cameras 122 may continuously capture images of the gaming environment 120. However, for various periods, no gaming activity of interest may occur in the gaming environment. Storing and transmission of images that do not include a gaming activity of interest may result in a wastage of computational, network and memory resources in the gaming monitoring system. In some embodiments, the edge computing device 124 serves as a gatekeeper of image data generated by the cameras 122 and performs the image processing operations necessary to identify image data relating to gaming events of interest that could be processed by the upstream computing devices to identify further insights.

At 1010, the edge computing device 124 receives a series of images of the gaming environment and timestamp information of a capture time of each image in the series of images. The series of images may be captured by one or more cameras 122. The timestamp information is used to determine temporal image order of an image from among multiple images. The timestamp information may include a numerical time value and/or a value indicative of a relative time value or temporal order. At 1020, the edge computing device 124 processes a first image in the series of images to determine a first event trigger indicator in the first image. The first event trigger indicator may include a detection of one or more game objects or one or more persons by the object detection module 212 in the first image.

At 1030, the edge computing device 124 identifies a gaming monitoring start event based on the determined first event trigger indicator. The gaming monitoring start event may relate to the start of a game on a gaming table 123 in the gaming environment 120. In some embodiments, responsive to determining the game monitoring start event, the edge computing device 124 may being storing, such as in a local hard drive (not shown), the captured images subsequent to the first image. The edge computing device 124 may also store one or more image meta data associated with each of the captured images, such as time stamp information.

At 1040, the edge computing device 124 processes a second image in the series of images to determine a second event trigger indicator in the second image. The second image being an image captured subsequent to the first image in the series of images capture by the camera 122. At 1050, the edge computing device 124 identifies a gaming monitoring end event based on the determined second trigger indicator. In some embodiments, the edge computing device 124 may cease the storage of the captured images, having stored a set of images comprising the first image, the second image and one or more intermediary images, captured after the first image, but before the second image. At 1060, responsive to identifying the gaming monitoring end event the edge computing device 124 transmits the set of images, and associated meta data, to an upstream computing device.

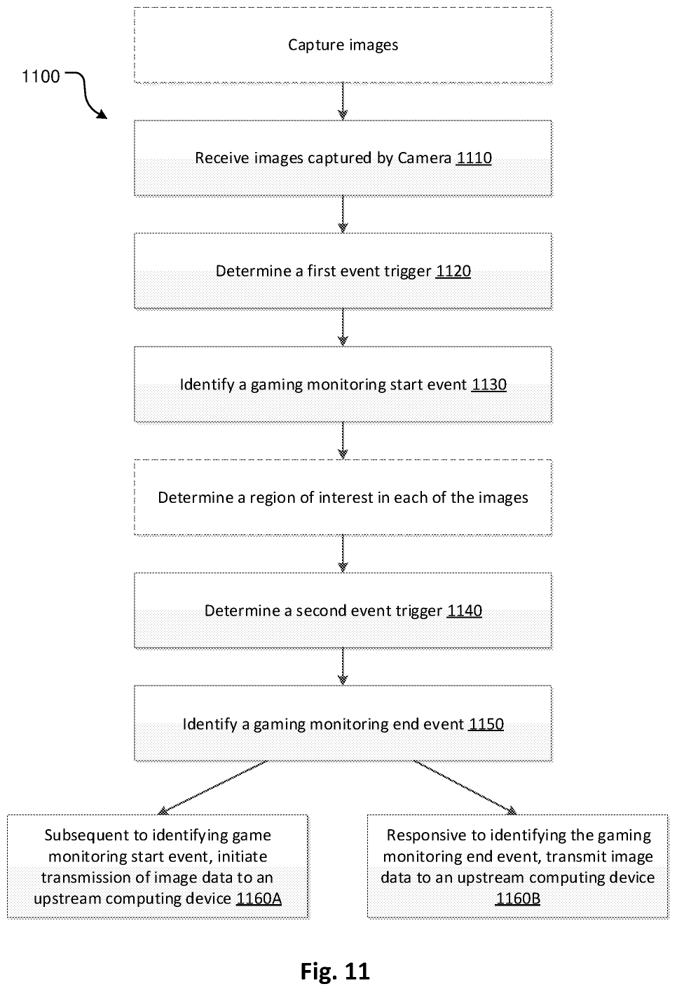

FIG. 11 illustrates a flowchart of a method 1100 of gaming monitoring capable of being performed by an edge computing device, according to some embodiments. The method 1100 performs image processing operations to identify images or image regions that are of interest for gaming monitoring. In some embodiments, cameras 122 may continuously capture images of the gaming environment 120. However, for various periods, no gaming activity of interest may occur in the gaming environment. Storing and transmission of images that do not include a gaming activity of interest may result in a wastage of computational, network and memory resources in the gaming monitoring system. In some embodiments, the edge computing device 124 serves as a gatekeeper of image data generated by the cameras 122 and performs the image processing operations necessary to identify image data relating to gaming events of interest that could be processed by the upstream computing devices to identify further insights.

At 1110, the edge computing device 124 receives a series of images of the gaming environment and timestamp information of a capture time of each image in the series of images. The series of images may be captured by one or more cameras 122. The timestamp information is used to determine temporal image order of an image from among multiple images. The timestamp information may include a numerical time value and/or a value indicative of a relative time value or temporal order.

At 1120, the edge computing device 124 determines a first event trigger indicator. The first trigger event indicator may be indicative of a game start event having recently occurred or that one may occur, or instructions for the edge computing device 124 to begin the process of identifying a game start event. The first trigger event indicator may be in relation to a gaming table.

In some embodiments, the first event trigger indicator may be a manual trigger. The manual trigger may comprise one or more of a signal sent from a button, switch, lever, touch screen, or otherwise input device, situated on or near the game table and/or dealer. The manual event trigger may also be transmitted from the upstream computing device or any other computing device in communication with the edge computing device 124. The manual trigger may be configured to indicate to the edge computing device that a game monitoring start event has occurred, or may occur, and to begin capturing images for analysis and/or determination. In some embodiments, the manual event trigger maybe used to filter out games that are not to be monitored, from games that are to be monitored. In some embodiments, the manual trigger event received from the upstream computing device may indicate that the upstream computing device is standing by to receive new or more data.

In some embodiments, the first event trigger may be a periodic event trigger, configured to be communicated to the edge computing device on, over or according to one or more predetermined time frames. For example, the upstream computing device and/or any other device in communication with edge computing device 124 may be configured to communicate a periodic first event trigger at one or more of: the beginning of a day, the beginning of a dealer shift, when a particular game table first becomes open to players after having not been open to players, after a predetermined number of elapsed games, and/or over a predetermined amount of time.

In some embodiments, the first event trigger may be a system status trigger, configured to be communicated to or determined by the edge computing device 124 upon a certain system requirement being met, threshold being exceeded or any other system related criteria or circumstance. For example, a system status first event trigger may be caused to be determined when the edge computing device 124 has completed transmitting image data, or upon receiving an indication from upstream computing device that it has not received data from edge computing device 124 for a predetermined amount of time, or upon the edge computing device determining that it has reached, and/or maintained a certain level of processor activity and/or heat build up for a predetermined period of time. In some embodiments, the first event trigger may be an indication that a game object has been detected by the edge computing device 124.

At 1130, the edge computing device 124 identifies a gaming monitoring start event based on the first event trigger indicator. The gaming monitoring start event may be an indication and/or instruction, indicating that the game, games or otherwise game related activity to be monitored have started. The gaming monitoring start event may comprise a determination, by the edge computing device 124, that a game object has been detected on the game table. In some embodiments, the first event trigger indicator may comprise the indication that a gaming monitoring start event has or will occur, and the edge computing device 124 identifies the game monitoring start event from the trigger indicator.

At 1140, the edge computing device determines a second event trigger indicator. The second trigger event indicator may be indicative of a game end event having recently occurred or that one may occur, or instructions for the edge computing device 124 to begin the process of identifying a game end event. The second trigger event indicator may be in relation to the gaming table.

In some embodiments, the second event trigger indicator may be a manual trigger. The manual trigger may comprise one or more of a signal sent from a button, switch, lever, touch screen, or otherwise input device, situated on or near the game table and/or dealer. The manual event trigger may also be transmitted from the upstream computing device or any other computing device in communication with the edge computing device 124. The manual trigger may be configured to indicate to the edge computing device that a game monitoring end event has occurred, or may occur, and to prepare to terminate the image capture process. In some embodiments, the manual event trigger may be used to filter out games that are not to be monitored, from games that are to be monitored. In some embodiments, the manual trigger event received from the upstream computing device may indicate that the upstream computing device has reached a processing and/or storage capacity and is not capable of receiving additional image data.

In some embodiments, the second event trigger may be a periodic event trigger, configured to be communicated to the edge computing device on, over or according to one or more predetermined time frames. For example, the upstream computing device and/or any other device in communication with edge computing device 124 may be configured to communicate a periodic second event trigger at one or more of: the end of a day, the end of a dealer shift, when a particular game table is closed to players after having been open to players, after a predetermined number of elapsed games, and/or over a predetermined amount of time.

In some embodiments, the second event trigger may be a system status trigger, configured to be communicated to or determined by the edge computing device 124 upon a certain system requirement being met, threshold being exceeded or any other system related criteria or circumstance. For example, a system status second event trigger may be caused to be determined when the edge computing device 124 has reached, and/or maintained a certain level of processor activity and/or heat build up, or upon receiving an indication from upstream computing device that it has reach a processor and/or storage capacity. In some embodiments, the second event trigger may be an indication that no game objects has been detected by the edge computing device 124 for one or more predetermined periods.

At 1150, the edge computing device identifies a gaming monitoring end event based on the determined second event trigger indicator. The game monitoring end event may be an indication and/or instruction, indicating that the game, games or otherwise game related activity to be monitored have concluded. The gaming monitoring end event may comprise a determination, by the edge computing device 124, that a game object has not been detected on the game table for one or more predetermined periods of time. In some embodiments, the second event trigger indicator may comprise the indication that a gaming monitoring end event has or will occur, and the edge computing device 124 identifies the game monitoring end event from the second trigger indicator.

At 1160A, the edge computing device, at any time subsequent to identifying the game monitoring start event, may initiate transmission of image data to the upstream computing device. The edge computing device 124 may be caused to initiate the transmission by one or more transmission triggers, such as determining the end of a round of betting, determining the end of a game, determining a predetermined elapsed time, determining a predetermined number of elapsed games, and/or receiving an instruction to transmit.

Alternative to 1160A, the edge computing device, at 1160B, may, in response to identifying the gaming monitoring end event, transmit image data to the upstream computing device.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for gaming monitoring, the method comprising:
receiving, by a computing device, a series of images and timestamp information of a capture time of each image in the series of images, wherein each image of the series of images is an image of a gaming environment;
processing, by the computing device, a first image in the series of images to determine a first event trigger indicator in the first image;
identifying a gaming monitoring start event based on the determined first event trigger indicator;
responsive to identifying the gaming monitoring start event, initiating transmission of image data of the first image and images in the series of images captured subsequent to the first image to an upstream computing device;
processing, by the computing device, a second image in the series of images to determine a second event trigger indicator in the second image, the second image being an image captured subsequent to the first image;
identifying a gaming monitoring end event based on the determined second trigger indicator; and
terminating transmission of the image data responsive to identifying the gaming monitoring end event.

2. The method of claim 1, wherein;
the first event trigger indicator is determined based on detection of a first game object in the first image, and
the first game object was not detected in an image captured prior to the first image in the series of images.

3. The method of claim 1, wherein;
the first event trigger indicator is determined based on detection of a dealer gesture in the first image, and
the dealer gesture is indicative of a start of a game.

4. The method of claim 1, wherein the first event trigger indicator is determined based on detection of a person or a part of a person in the first image.

5. The method of claim 1, wherein the second event trigger indicator is determined based on detection of an absence of a game object in the second image.

6. The method of claim 1, wherein;
the second event trigger indicator is determined based on detection of a dealer gesture in the second image, and
the dealer gesture is indicative of an end of a game.

7. The method of claim 1, further comprising capturing the series of images of the gaming environment.

8. The method of claim 7, wherein each image in the series of images is captured using a camera including a visual spectrum camera, an infrared spectrum camera, a depth sensing camera, a neuromorphic camera, an AI camera, an event camera, a pixel processing camera, or a combination thereof.

9. The method of claim 8, wherein the camera is at a same gaming table location as the computing device.

10. The method of claim 1, wherein the upstream computing device is remote from a location of the computing device.

11. The method of claim 1, wherein the upstream computing device includes a remote server in a cloud computing environment.

12. The method of claim 1, further comprising:
determining a region of interest in each of the first image and images in the series of images captured subsequent to the first image; and
wherein the image data transmitted to the upstream computing device is confined to the image data of the determined regions of interest.

13. The method of claim 12, wherein the region of interest is a region within the images depicting a game object, or a part of a person.

14. The method of claim 2, wherein the first game object includes a game value object, cash, a playing card, dice, a position marker, or a combination thereof.

15. The method of claim 1, wherein the computing device is a gaming environment computing device positioned in or proximate to the gaming environment.

16. The method of claim 1, wherein the gaming environment includes a gaming table and the captured images include a gaming table surface.

17. The method of claim 1, wherein the first event trigger indicator in the first image is determined based on providing the first image to an artificial intelligence model.

18. The method of claim 1, wherein the second event trigger indicator in the second image is determined based on providing the second image to an artificial intelligence model.

19. The method of claim 17, wherein the artificial intelligence model is an artificial neural network.

20. A method for gaming monitoring, the method comprising:
receiving, at an upstream computing device from a gaming environment computing device in a gaming environment, image data of images captured in the gaming environment and timestamp information for each of the captured images;
processing, at the upstream computing device, the received image data to identify a game object in the image data and an image region of the image data corresponding to the identified game object; and
processing, at the upstream computing device, the image region corresponding to the identified game object to determine a game object attribute of the identified game object.

21. The method of claim 20, wherein:
the game object includes a plurality of token objects, and
the game object attribute determined for the plurality of token objects includes a value estimate of the plurality of token objects and a position indicator of the plurality of token objects.

22. The method of claim 21, wherein the position indicator is configured to indicate a position of the plurality of token objects on a gaming table in the gaming environment.

23. The method of claim 21, wherein the plurality of token objects are arranged in a stack.

24. The method of claim 21, wherein the value estimate of the plurality of token objects is determined by:
detecting edge pattern regions in the image region corresponding to the plurality of token objects;
processing the edge pattern regions to determine a token value indication encoded in respective edge pattern regions; and
estimating the value of the plurality of token objects based on the token value indication.

25. The method of claim 24, wherein:
detection of the game objects is performed by a first object detection neural network; and
the detection of the edge pattern regions and the determination of the token value indication is performed by a second object detection neural network.

26. The method of claim 25, wherein the first object detection neural network and the second object detection neural network are implemented using a deep neural network.

27. The method of claim 20, wherein:
the game object includes a gaming card, and
the game object attribute of the gaming card includes a gaming card identifier.

28. A distributed system for gaming monitoring, the distributed system comprising:
a camera positioned in a gaming environment and configured to capture images of the gaming environment;
a gaming environment computing device positioned in or proximate to the gaming environment, the computing device configured to be in communication with the camera; and
an upstream computing device configured to be in communication with the computing device; and
wherein the gaming environment computing device is configured to:
receive by the gaming environment computing device a series of images and timestamp information of a capture time of each image in the series of images, wherein each image of the series of images is an image of a gaming environment;
process a first image in the series of images to determine a first event trigger indicator in the first image;
identify a gaming monitoring start event based on the determined first event trigger indicator;
responsive to identification of the gaming monitoring start event, initiate transmission of image data of the first image and images in the series of images captured subsequent to the first image to an upstream computing device;
process a second image in the series of images to determine a second event trigger indicator in the second image, the second image being an image captured subsequent to the first image;
identify a gaming monitoring end event based on the determined second trigger indicator; and
terminate transmission of the image data responsive to identification of the gaming monitoring end event; and
wherein the upstream computing device is configured to:
receive, at an upstream computing device from a gaming environment computing device in a gaming environment, image data of images captured in the gaming environment and timestamp information for each of the captured images;
process the received image data to identify a game object in the image data and an image region of the image data corresponding to the identified game object; and
process the image region corresponding to the identified game object to determine a game object attribute of the identified game object.

29. (canceled)

30. A method for gaming monitoring, the method comprising:
receiving, by a computing device, a series of images and timestamp information of a capture time of each image in the series of images, wherein each image of the series of images is an image of a gaming environment;
processing, by the computing device, a first image in the series of images to determine an event trigger indicator in the first image;
identifying a gaming monitoring event based on the determined event trigger indicator; and
transmitting image data of the first image and images proximate to the first image in the series of images to an upstream computing device; and
wherein the event trigger indicator is determined based on detection of a first game object in the first image, and
wherein the first game object was not detected in an image captured prior to the first image in the series of images.

31. A method for gaming monitoring, the method comprising:
receiving, by a computing device, a series of images and timestamp information of a capture time of each image in the series of images, wherein each image of the series of images is an image of a gaming environment;
processing, by the computing device, a first image in the series of images to determine a first event trigger indicator in the first image;
identifying a gaming monitoring start event based on the determined first event trigger indicator;
processing, by the computing device, a second image in the series of images to determine a second event trigger indicator in the second image, the second image being an image captured subsequent to the first image;
identifying a gaming monitoring end event based on the determined second trigger indicator; and
responsive to identifying the gaming monitoring end event, transmitting image data of a set of images in the series of images from the first image to the second image to an upstream computing device for remote image processing of the set of images using artificial intelligence.

32. A method for gaming monitoring, the method comprising:
receiving, by a computing device, a series of images and timestamp information of a capture time of each image in the series of images, wherein each image of the series of images is an image of a gaming environment;
determining, by the computing device, a first event trigger indicator in relation to a gaming table in the gaming environment;
identifying a gaming monitoring start event based on the determined first event trigger indicator;
determining, by the computing device, a second event trigger indicator in relation to the gaming table at a time after determination of the first trigger event;
identifying a gaming monitoring end event based on the determined second event trigger indicator; and
one of:
subsequent to identifying the gaming monitoring start event, initiating transmission of image data of a set of images including a first image captured at a time of the first event trigger indicator and images in the series of images captured subsequent to the first image to an upstream computing device for remote image processing of the set of images using artificial intelligence, and subsequent to identifying the gaming monitoring end event, terminating transmission of the image data; or
responsive to identifying the gaming monitoring end event, transmitting image data of a set of images in the series of images from the first image captured at a time of the first event trigger indicator to a second image captured at a time of the second event trigger indicator to an upstream computing device for remote image processing of the set of images using artificial intelligence.

33. The method of claim 32, further comprising capturing the series of images of the gaming environment.

34. The method of claim 33, wherein each image in the series of images is captured using a camera including a visual spectrum camera, an infrared spectrum camera, a depth sensing camera, a neuromorphic camera, or a combination thereof.

35. The method of claim 34, wherein the camera is at a same gaming table location as the computing device.

36. The method of claim 32, wherein the upstream computing device is remote from a location of the computing device.

37. The method of claim 32, wherein the upstream computing device includes a remote server in a cloud computing environment.

38. The method of claim 32, further comprising:
determining a region of interest in each of the first image and images in the series of images captured subsequent to the first image; and
wherein the image data transmitted to the upstream computing device is confined to the image data of the determined regions of interest.

39. The method of claim 38, wherein the region of interest is a region within the images depicting a game object, or a part of a person.

40. The method of claim 32, wherein the computing device is a gaming environment computing device positioned in or proximate to the gaming environment.

41. The method of claim 32, wherein the gaming environment includes a gaming table and the captured images include a gaming table surface.

42. A method of gaming monitoring, the method comprising:
receiving, by an edge computing device, a series of images and timestamp information of a capture time of each image in the series of images, wherein each image of the series of images is an image of a gaming environment;
processing, by the edge computing device, a first image in the series of images to determine a first event trigger indicator in the first image;
identifying a gaming monitoring start event based on the determined first event trigger indicator;
responsive to identifying the gaming monitoring start event, initiating transmission of image data of the first image and images in the series of images captured subsequent to the first image to an upstream computing device;
receiving, at the upstream computing device from the edge computing device, the image data of the first image and each of the images in the series of images captured subsequent to the first image and timestamp information for the first image and images in the series of images;
processing, at the upstream computing device, the received image data to identify a game object in the image data and an image region of the image data corresponding to the identified game object;
processing, at the upstream computing device, the image region corresponding to the identified game object to determine a game object attribute of the identified game object;
processing, by the edge computing device, a second image in the series of images to determine a second event trigger indicator in the second image, the second image being an image captured subsequent to the first image;
identifying a gaming monitoring end event based on the determined second trigger indicator; and
terminating transmission of the image data responsive to identifying the gaming monitoring end event.
